(19) United States
(12) Patent Application Publication
(10) Pub. No.: US 2003/0209641 A1
(43) Pub. Date: Nov. 13, 2003

(54) Wrist support device

(76) Inventor: Michael Charles Cooke, Ascot (AU)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/459,345

(22) Filed: Jun. 11, 2003

Related U.S. Application Data
(63) Continuation of application No. 09/554,253, filed on Jul. 5, 2000, now abandoned.

(30) Foreign Application Priority Data
Nov. 11, 1997 (AU) PP0294

(51) Int. Cl. B68G 5/00

(52) U.S. Cl. 248/118; 248/918

(57) ABSTRACT

A device for supporting a wrist of a person operating a computer mouse or keyboard, the device includes a deformable body having a flexible enclosure which is at least partially filled with a flowable material such as a fluid, liquid or gel; and a support member being less deformable than said body, wherein the deformable body is movable relative to the support member. The support member may include a second enclosure containing a flowable material or alternatively a deformable solid material. Suitably, a flexible plate member is associated with the second enclosure in order to resist bunching thereof when the support device is in use.

### CROSS-REFERENCE TO RELATED APPLICATIONS

This application is a continuation of application Ser. No. 09/554,253, filed Jul. 5, 2000.

### BACKGROUND OF THE INVENTION

The present invention relates to a support device which affords support to a wrist of a person operating apparatus such as a computer mouse, digitizer, keypad or keyboard.

The present invention will be described with particular reference to the operation of a computer mouse. However, it will be appreciated that the device may also be used by operators of other hand operated apparatus such as digitizers or keyboards and no limitation is intended thereby.

Prolonged use of apparatus such as a computer mouse may result in repetitive strain injuries and in particular carpal tunnel syndrome. The carpal tunnel is a membrane located in the wrist through which the median nerve, tendons and other tissues pass. Carpal tunnel syndrome refers to injury caused by inflammation of tendons and other tissues in the carpal tunnel. Such inflammation constricts the median nerve and in severe cases, the median nerve may be damaged. Persons suffering from carpal tunnel syndrome experience severe pain and may also lose the range of motion of the wrist and hands.

Prolonged bending and movement of the fingers when operating a typewriter or keyboard and compression of the tissues by resting the wrist on a hard surface have been identified as major contributors to repetitive strain injuries and carpal tunnel syndrome. Accordingly, there have been a number of devices designed to maintain the wrist in a straight position during use of a typewriter or keyboard.

Examples of such proposals include simple foam cushions for supporting the wrist to complicated mechanical supports mounted on rollers. However foam cushions, such as described in U.S. Pat. No. 5,163,646 in the name of Engelhart, provide only a limited adaptability to conform to the shape of a user's hand and do not sufficiently relieve the pressure on the wrist so as to alleviate the likelihood of injury. The mechanical supports simply maintain the wrist in a level position and do nothing to alleviate the problems caused by compression of the wrist on a hard surface.

Recently it has been proposed to provide deformable gel-filled packs for supporting the wrist, such as those described in U.S. Pat. Nos. 5,547,154 and 5,713,544, both assigned to Minnesota, Mining and Manufacturing Company, along with International Publication No. WO 96/06744 in the name of Sereboff. These known packs are primarily designed for use with a typewriter or keyboard. Their aim is to maintain the wrist in a straight position, prevent compression of the wrist tissues and to minimise stress caused by repetitive finger movement. Generally, the packs are attached to a stationary support and remain stationary during use, which is suitable for operation of standard keyboards in which the main movement is of the fingers.

However, a stationary pack is not suitable for use with the operation of a computer mouse or enhanced keyboards (consider the function key arrays or larger custom keyboards such as employed on purpose built control desks) in which there is movement of the hand, wrist and forearm across a surface together with upper arm and shoulder movement. The user must still drag the hand and/or wrist across the surface of the known pack. Thus, the forces generated by friction between the hand and the surface upon which the hand is placed are not significantly reduced. These forces may contribute to inflammation of the tissues in the hand, wrist, forearm, upper arm, shoulder, neck, back of the upper torso and carpal tunnel.

Further, the known packs do not provide uniform support and stability for the wrist over the whole range of movement required for full operation of the mouse, as the wrist must be repeatedly lifted from the pack to achieve the desired movement. Thus these known packs are not considered to be entirely satisfactory for use by a person operating a computer mouse, larger (non-standard) keyboards, control desks or similar devices.

### OBJECT OF THE INVENTION

It is an object of the present invention to provide a device for supporting the wrist of a person when using a computer mouse or other hand operated device, which may overcome or ameliorate the above problems or disadvantages, or at least provide the public with a useful choice.

It is another object of the present invention to provide a device for supporting the wrist of a person when using a computer mouse or other hand operated device which supports and cushions the wrist and hand, allowing a range of low friction motion of the hand during such manual operations.

Further objects will be apparent from the following description.

### DISCLOSURE OF THE INVENTION

According to a first broad form of the present invention there is provided a device for supporting a wrist of a person operating a computer mouse or keyboard, the device including a deformable body having a flexible enclosure which is at least partially filled with a flowable material; and a support member being less deformable than said body, wherein the deformable body is movable relative to the support member.

Preferably the flexible enclosure is formed by an inner surface of the support member, wherein suitably the flowable material may be partly or wholly contained within an outer support member layer.

According to a second broad form of the present invention there is provided a device for supporting a wrist of a person operating a computer mouse or keyboard, the device including a deformable body having a first flexible enclosure which is at least partially filled with a first flowable material; a support member disposed within the first enclosure, which support member has a second flexible enclosure which is at least partially filled with a second flowable material; whereby said support member is less deformable than the deformable body and said deformable body is movable relative to the support member.

The first enclosure is preferably made from or covered by a material which has a comfortable feel to a user's skin, such as lycra covered neoprene. Covers of nylon, polyester, and/or cotton materials may alternatively be used to minimise and/or absorb perspiration. The enclosure may optionally be constructed of plastics material, such as polyurethane. The shape and size of the enclosure may be varied to suit different keyboards as desired. Typically the enclosure is sized such that a person's wrist and palm can rest comfortably thereon.

The first flowable material may be selected from a fluid, a viscosity modified liquid or gel. Preferably, the first flowable material is thixotropic, such as a silicone oil or a gel. The first enclosure may also contain optional additives such as antioxidants, antibacterial agents, dyes, glitter or phosphorescent materials. Alternatively, the first flowable material may include a plurality of solid particles such as microspheres. If required, the enclosure may include a valve means for adjusting the amount of the first flowable material therein.

The support member is suitably less deformable than its surrounding enclosure. Typically the support member provides vertical support to the wrist during use. Preferably the support member is of a height which is equal to or less than the height required to maintain a user's wrist in a substantially straight position. Optionally the second flexible enclosure may be of a multicellular construction.

The second flowable material may be the same or a different material to that in the first enclosure. Preferably, the second flowable material contained in the second enclosure is thicker or more viscous than the first flowable material. In this case, the deformability of the support member may be decreased by increasing the fill volume of the support enclosure. The second enclosure may further include a mechanical adjustment means, such as an outer slidable collar member disposed on the enclosure, for adjusting its deformability.

It will be appreciated that the relative degree of deformability in either enclosure may be modified as desired by selecting different fill volumes, densities and viscosities of the respective flowable materials. Furthermore, the use of different materials for the first and second enclosures, or the same material having different characteristics, may also influence the relative degree of deformability. Suitably, the flowable materials are selected such that desired physical characterisics, particularly temperature-viscosity, are optimal when in use whereby the flowable materials are influenced by the user's body temperature.

Optionally, the wrist support device further includes means associated with the support member for resisting the bunching or folding of said support member when the device is in use. The means for resisting bunching may comprise a resilient plate member, flexible attachments or reinforcing filaments. The resilient plate member is suitably disposed in the support enclosure. The flexible attachments link peripheral portions of the support member to the first enclosure. In the case of a support enclosure of multicellular construction, the upright cell walls may provide the necessary resistance.

According to a third broad form of the invention, there is provided a device for supporting a wrist of a person operating a computer mouse or keyboard, the device including a deformable body having a first flexible enclosure which is at least partially filled with a first flowable material; and a support member made from a deformable solid material; said support member disposed within said first enclosure and being less deformable than the deformable body and said deformable body is movable relative to the support member.

Suitable deformable solid materials may include elastomers such as rubbers, thermoplastic elastomers, thermo-reactive polymers, urethane foams, aerogels or the like.

According to a fourth broad form of the invention there is provided a device for supporting the wrist of a person operating a computer mouse or keyboard, the device including a support member having an upper surface; a deformable body having a flexible enclosure which is at least partially filled with a flowable material and having a lower surface disposed in low friction sliding relation to the upper surface of the support member; and biasing means resisting coplanar sliding movement of said deformable body relative to the support member.

Suitably one or both of the upper surface and the lower surface may be coated with a low friction material such as teflon. Alternatively, one of the surfaces may include a mechanical low friction arrangement, such as roller bearings.

Preferably the biasing means comprises a folded strip of soft resilient material with a first end attached to a lateral portion of the support member and a second end attached to a lateral portion of the deformable body The resilient material may be composed of neoprene, silicone rubber or the like.

### BRIEF DETAILS OF THE DRAWINGS

By way of example only, the present invention will now be described with reference to the accompanying figures in which:

FIG. 1 is a cross-sectional side view of a wrist support device of a first embodiment;

FIGS. 2 and 2A are cross-sectional side views of the device of FIG. 1 in use;

FIG. 3 is a top plan view of the device of FIG. 1 in use.

FIG. 4 is a cross-sectional front view of a wrist support device of a second embodiment;

FIG. 5 is a top plan view of a pair of wrist support devices of FIG. 4;

FIG. 6 is a top plan view of a wrist support of a third embodiment;

FIG. 7 is a cross-sectional side view of a wrist support device of a fourth embodiment;

FIG. 8 is a perspective view of the wrist support device of FIG. 7;

FIG. 9 is a cross-sectional side view of a wrist support device of a fifth embodiment;

FIG. 10 is a cross-sectional side view of a wrist support device of a sixth embodiment;

FIG. 11 is a perspective view of the wrist support device of FIG. 10;

FIGS. 12A and 12B are top plan views of the wrist support device of FIGS. 10 and 11, when in use;

FIG. 13 is a cross sectional front view of a wrist support device of a seventh embodiment;

FIG. 14 is a top plan view of the wrist support device of FIG. 13;

FIG. 15 is a top plan view of the wrist support device of FIG. 13, when in use; and

FIG. 16 is a top plan view of a wrist support device of an eighth embodiment.

### DETAILED DESCRIPTION OF THE PREFERRED EMBODIMENTS

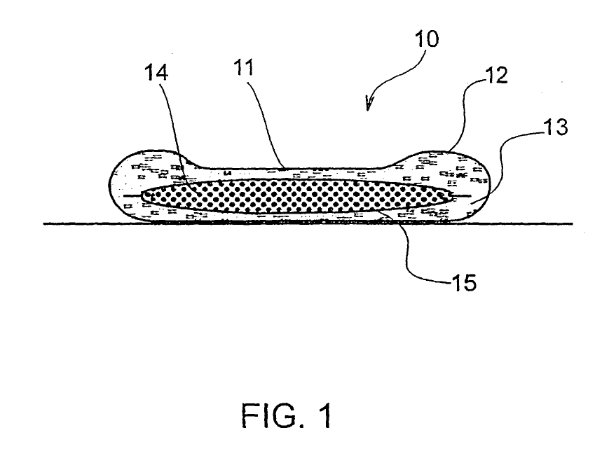

FIG. 1 illustrates a wrist support device 10 of a first embodiment. The device has a deformable body 11 including a flexible enclosure 12 in the form of a bladder or sac, which contains a first flowable material 13, such as a silicone oil. A support member 14 is housed within the enclosure 12 of the body 11 in the embodiment. The flexible enclosure of the embodiment is made from polyurethane having a wall thickness in the range of 0.75 mm to 0.9 mm. The support member also includes a bladder or sac filled with a second flowable material 15, such as a gel, which is more viscous than the silicone oil comprising the first flowable material 13. A suitable gel is a polyvinyl alcohol (PVA) gel cross-linked with sodium tetraborate, suitably in a mix ratio of 10:1 (PVA: sodium tetraborate). In the embodiment the support sac is also made of polyurethane, but has a wall thickness in the range 0.85 mm to 1.1 mm. The deformable body 11 is movable relative to the support member 14 of the device.

The outer enclosure 12 of the support device of the embodiment is sized such that an adult's wrist and palm can rest comfortably on the support. The outer enclosure of the embodiment is approximately 95 mm square and contains about 40 ml of silicone oil, whilst the support enclosure is around 80 mm square and contains approximately 36 g of the PVA gel. The kinematic viscosity of the first flowable material may be in the range from 205 c/s to 165 c/s, preferably being 185 c/s; whilst the limiting viscosity of the second flowable material may be in the range from 16 cm³/g to 20 cm³/s, preferably being 18.1 cm³/s. The second flowable material preferably has a density of 0.9 g/ml. Both enclosures are also evacuated in the embodiment.

In other embodiments, the flowable material may be selected from a fluid, a viscosity modified liquid or gel. Suitable liquids include water, polyhydric alcohols such as glycerol and polyethylene glycol. Suitable organic gelling or viscosity modifying agents include cellulose based materials such as hydroxymethylcellulose and carboxymethylcellulose, hydrocolloids such as guar gum, agar, and starches. Inorganic viscosity modifying agents which may also be used include clays and attapulgite.

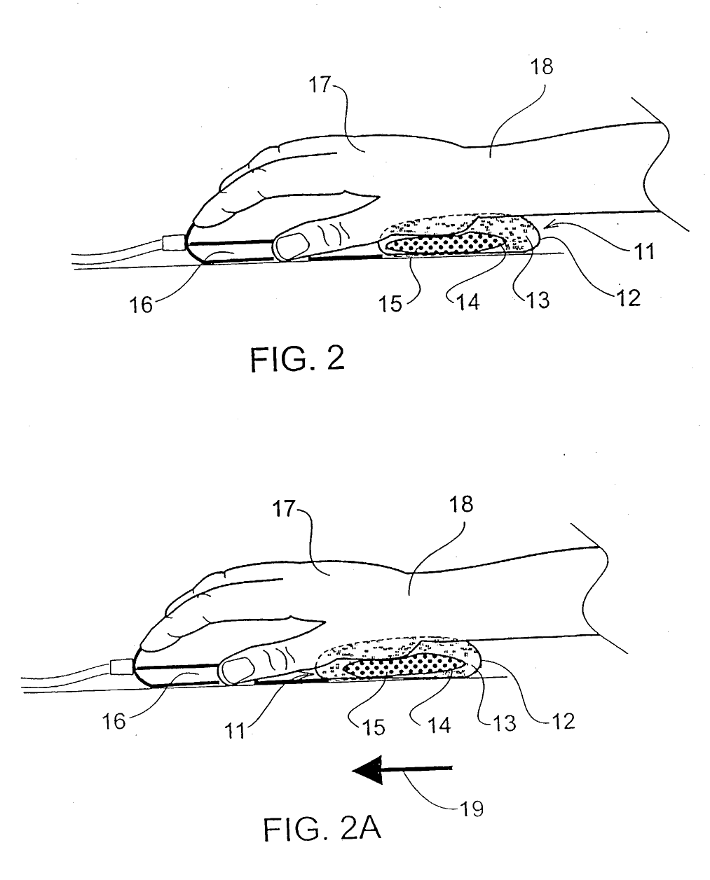

FIG. 2 illustrates the wrist support device 10 in use. The device 10 is located on a work surface near a computer mouse 16. The mouse is held by a hand 17 of a person operating the mouse. The person's wrist 18 and palm rest on the device 10. The deformable body 11 deforms and moulds to the shape of the wrist and palm and provides lateral support for the hand. The device 10 provides an impact absorbing surface for the wrist and palm, reducing the point force loads which are normally experienced by the wrist and hand when resting on a hard surface.

The ability to mould about the shape of a person's hand also enables the device to be used by right or left handed persons and those having different sized hands and wrists. This deformability also allows the device to adapt to the shape or any jewellery worn by a person. The support member 14 provides vertical support for the wrist 18. It can be seen that the support member supports the wrist at a level such that the wrist is substantially straight during operation of the mouse.

FIG. 2A is identical to FIG. 2 except that the hand 17 and mouse 16 have moved forward in the direction indicated by the arrow 19. The deformable body 11 has moved forward with the motion of the hand cushioning the wrist and hand with respect to the support member 14, which support member remains substantially stationary. Because the outer enclosure 12 moves with the hand 17, negligible friction is generated when the hand is moved during mouse operation. The physical characteristics of the flowable material 15 contained in the enclosure 12 allow the hand 17 to glide, as the deformable body 11 carrying the hand moves relative to the support member 14. Further, the wrist is maintained at the same vertical height and thus in a straight position as it rests on support member 14.

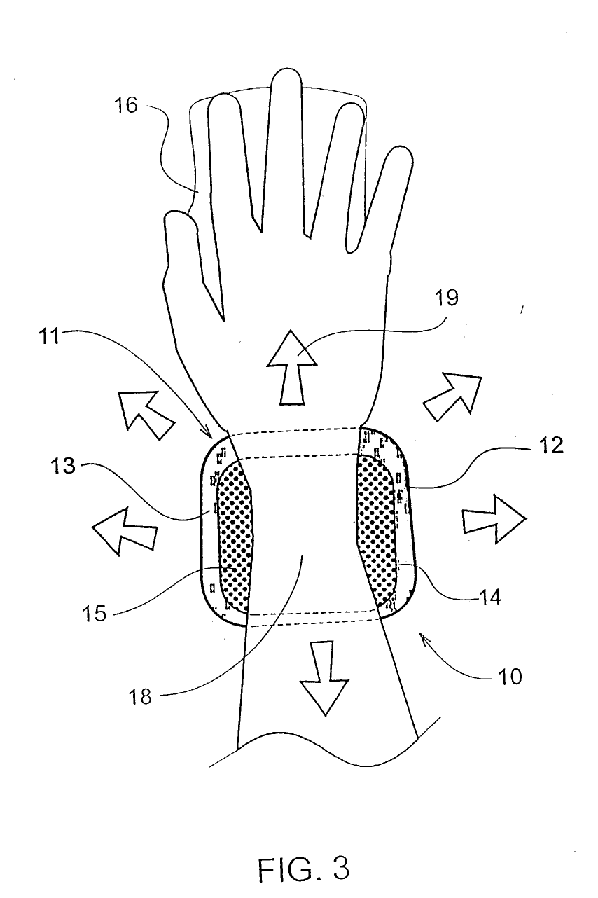

FIG. 3 illustrates a plan view of the device 10 of FIG. 1 in use, wherein the hand 17 and wrist 18 have moved further forward in the direction of arrow 19. It will be appreciated that movement of the hand laterally (as indicated by the unreferenced arrows) is also facilitated by the device 10, as the support member 14 is also of smaller width than the enclosure 12 of the deformable body 11. The relative length and width of the support member and deformable body are selected to influence the range of motion available (see also the discussion of FIG. 6 below). In particular, the flexible enclosure 12 enables the device 10 to roll over the work surface in a manner similar to an endless track; whilst the internal support member remains stationary with respect to the work surface. The available range of motion is influenced by the relative sizes of the support member and the deformable body. An added advantage of the device of the present invention is that the hand moves more easily so as to give greater control of the mouse. This is particularly useful for tasks requiring precision input, such as computer aided design.

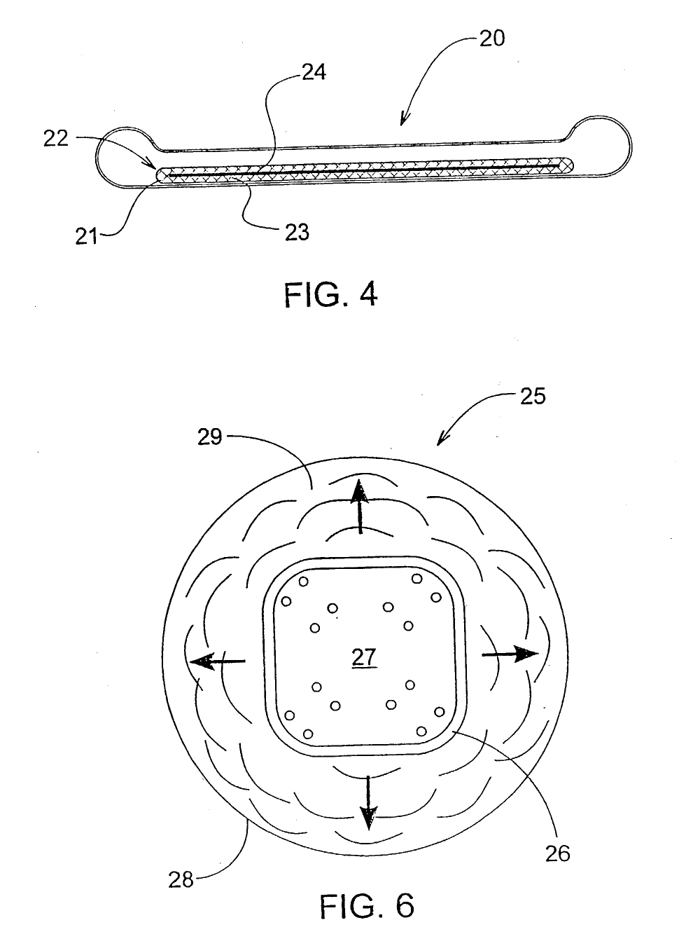

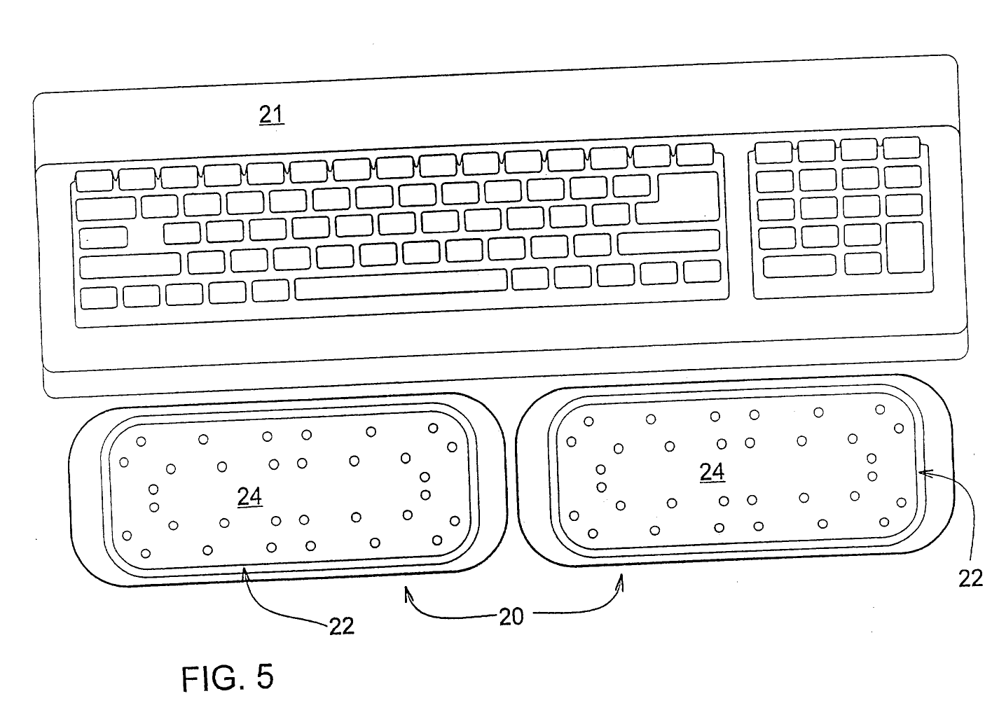

FIGS. 4 and 5 illustrate a wrist support device 20 of a second embodiment. The device 20 is somewhat more elongate than the first embodiment, preferably being between 150 mm and 250 mm in length, and thus suitable for use with a computer keyboard 21. Two of the devices 20 may be used together with the keyboard, as shown in FIG. 5, so that each hand is supported independently. The present embodiment has a structure similar to that of the first embodiment, except that the flexible enclosure 21 of the support member 22 contains both a gel 23 and a resilient plate member 24. The plate member may be composed of extruded low density polyethelene or PVA plastics. The plate member, which is approximately 0.72 mm thick, functions to resist the folding or bunching of the support member 22 when the device 20 is in use. Other embodiments may of course be in the form of a single unitary wrist support, preferably being 300 mm to 500 mm in length.

FIG. 6 shows a wrist support device 25 of a third embodiment which includes a support member 26 of similar dimensions to that of the first embodiment illustrated in FIGS. 1 to 4 and including a suitable resilient plate member 27 to prevent bunching. However, it can be seen that the flexible enclosure 28 containing the less viscous gel 29 of the deformable body has a relatively larger size than the first embodiment. Accordingly, the device 25 of the third embodiment provides a greater range of motion when in use. Support devices of similar construction to the third embodiment may find more general application for supporting knees, elbows or other limbs as required for anatomical purposes. Furthermore, medical applications for the support device are also apparent, such as for use in minimising or alleviating pressure sores in bed-ridden patients. Support devices which contain a suitable gel may also be heated or cooled for therapeutic purposes.

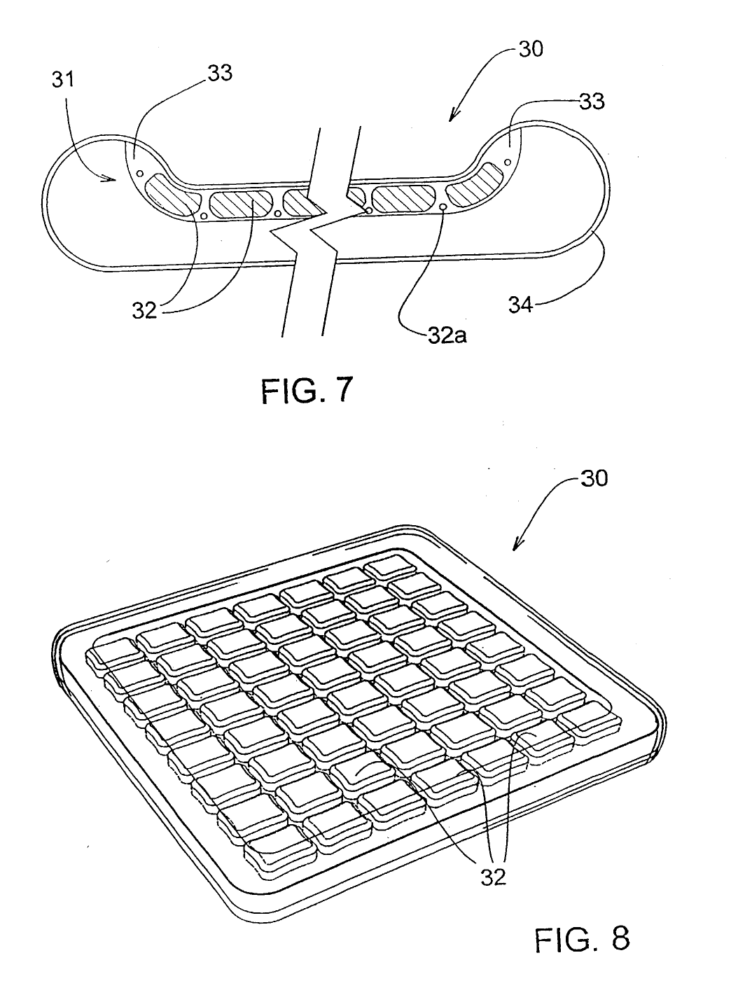

FIGS. 7 and 8 illustrate a wrist support device 30 of a fourth embodiment. The support member 31 of the present embodiment is of multicellular construction wherein the cells 32 contain a gas, typically air. In order to resist bunching of the support member, a support enclosure 33 is elastically attached at peripheral portions thereof to a flexible enclosure 34 of the deformable body. In another arrangement the vertical walls of the cells 32 may be of less flexible construction than the remainder of the flexible enclosure or alternatively reinforcing filaments 32a (illustrated in FIG. 7), such as polymer rods or tubes, may be incorporated into the support member 31. In a further embodiment (similar to the fourth embodiment, but not illustrated), an outer wall of support enclosure may be fixed to an inner wall of the flexible enclosure; preferably in face-to-face relation.

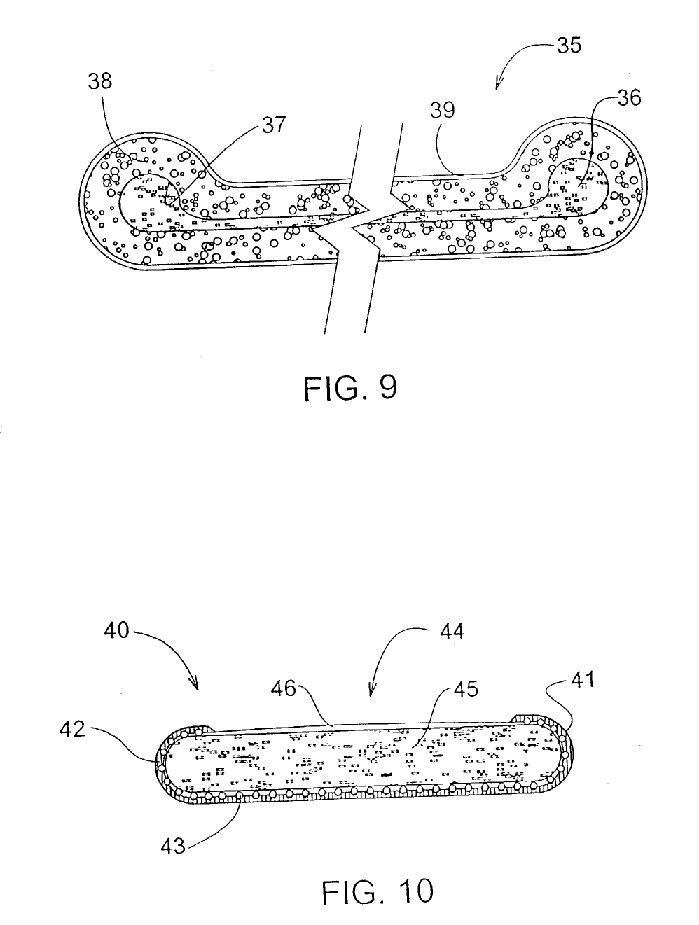

FIG. 9 illustrates a wrist support device 35 of a fifth embodiment of the present invention. The flexible enclosure for the deformable body of flowable material 36 is formed by an inner surface 37 of the support member 38. The support member of this embodiment is formed from a layer 38 of flexible foamed plastics material, such as urethane. The device 35 also includes an outer cover 39 of a soft perspiration resistant material, which has a comfortable feel to a user's skin.

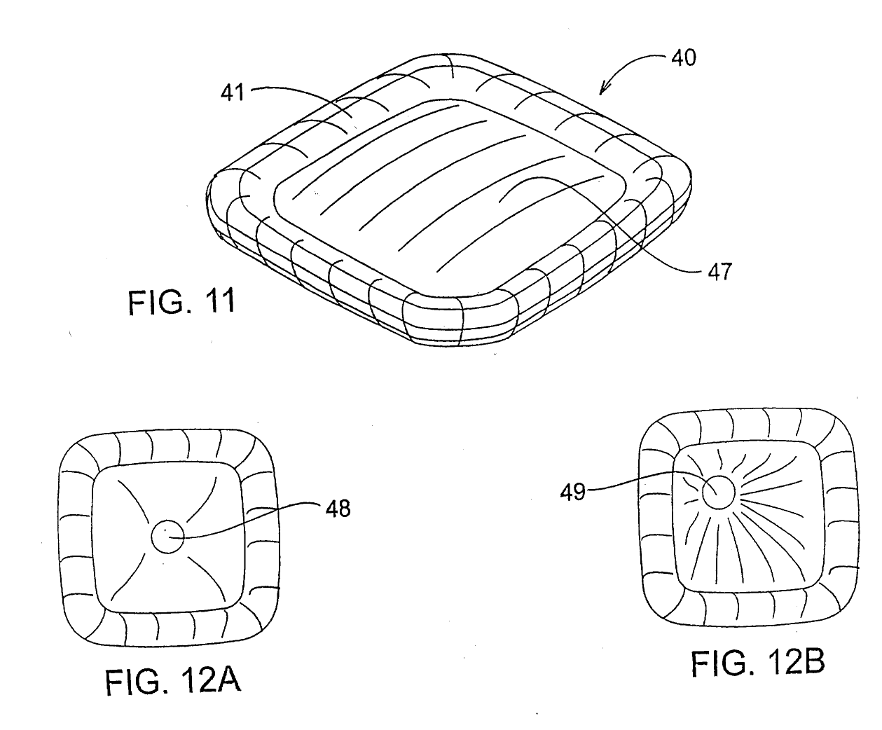

FIGS. 10 and 11 illustrate a wrist support device 40 of a sixth embodiment. The device 40 comprises a support member 42 including a rigid outer shell or casing 41 composed of polycarbonate or ABS plastics. The support member 42 further includes a low friction arrangement, such as a series of roller bearings 43. A deformable body 44 is supported within the casing 41 by the support member 42. The deformable body is in the form of a flexible enclosure 45, such as neoprene, which contains a flowable material, preferably a gel 46. The deformable body 44 is retained in the casing 41 by an extremely elastic material, such as lycra™ 47. The lycra material is sufficiently elastic such that it allows a user's wrist move from a rest position 48 (as depicted in FIG. 12A) to a usage position 49 (as depicted in FIG. 12B). During this movement, the deformable body 44 carries the wrist, but is freely movable relative to the support member 42.

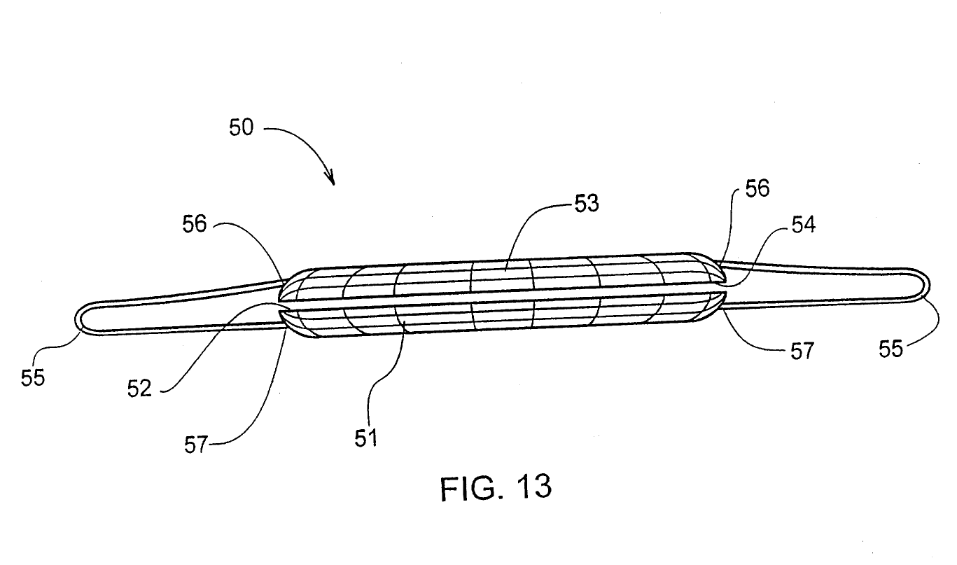

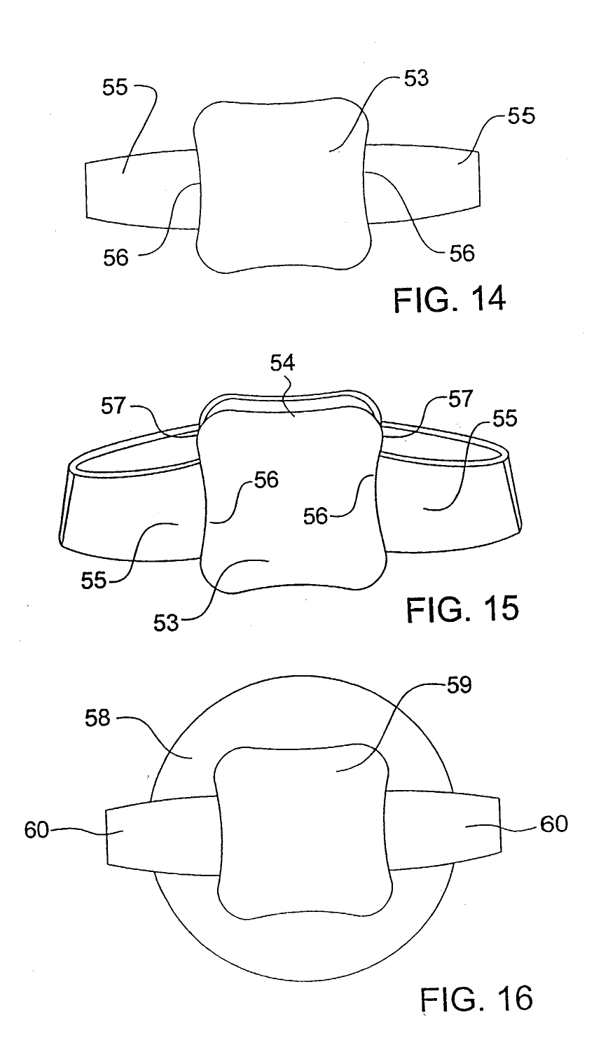

FIGS. 13 and 14 illustrate a wrist support device 50 of a seventh embodiment. The device 50 includes a support member 51, which may be a gel filled sac or an elastomeric solid, having a low friction upper surface 52. A deformable body 53, preferably composed a gel filled sac whereby the support member is less deformable than the body, has a lower surface 54 disposed in face to face relation the upper surface 52 of the support member 51. Biasing means are provided to maintain the deformable body and support member in substantial alignment. The biasing means of the embodiment are a pair of folded strips of soft flexible material, such as neoprene or silicone rubber. The upper ends 56 of the strips are attached to a peripheral lateral portion of the deformable body 53; whilst the lower ends 57 of the strips are attached to a peripheral lateral portion of the support member 51.

FIG. 15 illustrates the device 50 of the seventh embodiment shown with the deformable body 53 displaced relative to the support member 54, as it would be in use. It will be appreciated that the biasing strips 55 will tend to resist the coplanar sliding movement of the deformable body relative to the support member, providing a return or self-aligning action. The eighth embodiment of the device shown in FIG. 16 dispenses with the deformable body and merely includes an enlarged low friction surface 58, such as one coated with teflon, whereupon the deformable body 59 may slide. A secondary function of the biasing strips 60 is to prevent separation of the two components of the wrist support device.

It can be seen that use of the device of the present invention enables a user's wrist to be maintained in a level position. This minimises stress to the forearm, neck and shoulders. It also enables the movement of the mouse to be transferred from the wrist to the muscles of the arms. This also reduces stress on the wrist. The device moulds to the shape of a user's wrist and palm and provides cushioned vertical support throughout the whole range of movement necessary for operation of a computer mouse. This minimises point force loads. Still further, friction between the user's hand and the work surface is minimised by the relative motion of the deformable body with respect to the support member.

Support devices of a larger scale find application as anatomical supports for human limbs and bodies, and may be heated or cooled prior to use for therapeutic purposes.

Throughout the specification the aim has been to describe the preferred embodiments of the invention without limiting the invention to any one embodiment or specific collection of features.

1. A device for supporting a wrist comprising an enclosure having a flexible outer wall in the form of a bladder or sac, a first flowable material contained within the flexible outer wall selected from a liquid, a viscosity modified liquid, and a gel, and an inner support member within the flexible outer wall and wherein the outer wall is able to roll over a work surface and relative to the inner support member.

2. The device as claimed in claim 1 wherein the inner support is generally planar.

3. The device as claimed in claim 2 wherein the flexible outer wall has a thickness of between 0.75 mm and 0.9 mm.

4. The device as claimed in claim 3 wherein the flexible outer wall comprises polyurethane.

5. The device as claimed in claim 1 wherein the first flowable material comprises silicon oil.

6. The device as claimed in claim 1 wherein the kinematic viscosity of the first flowable material is between 205 c/s and 165 c/s.

7. The device as claimed in claim 1 wherein the flexible outer wall has the ability to mould to the shape of a person's hand.

8. The device as claimed in claim 2 wherein the inner support member comprises extruded low density polyethylene.

9. The device as claimed in claim 1, wherein the inner support is configured to be locatable within the enclosure at a position where its peripheral edge is spaced away from the outer wall.

10. The device as claimed in claim 1 wherein the outer wall has a bulbous peripheral edge.

11. The device as claimed in claim 1 wherein the distance between top and bottom surfaces of the device is greater around the peripheral edge.

12. The device as claimed in claim 1 wherein the flexible outer wall defines an internal chamber containing a plurality of cells.

13. The device as claimed in claim 2 wherein the plurality of cells contain a gas.

14. The device as claimed in claim 13 wherein the cells have upright walls which are arranged to provide resistance to bunching or folding when the device is in use.

15. The device as claimed in claim 1 wherein the first flowable material is thixotropic, being selected from a viscosity modified liquid or gel.

16. The device as claimed in claim 1 wherein the first flowable material includes a plurality of solid particles.

17. The device as claimed in claim 1 wherein the inner support is less deformable than the outer wall.

18. The device as claimed in claim 1 wherein the inner support has a height which is equal to or less than the height required to maintain a user's wrist in a substantially straight position.

19. The device as claimed in claim 1, wherein the inner support comprises an inner chamber with a second flowable material therein.

20. The device as claimed in claim 19, wherein the second flowable material has greater viscosity than the first flowable material.

21. The device as claimed in claim 1, wherein the interior support member comprises a plastics material.

22. The device as claimed in claim 1, wherein the inner support member is in the form of a substantially flat plate member adapted to resist bunching of the inner support.

23. The device as claimed in claim 1 wherein the inner support is untethered and freely movable within the boundaries of the outer wall.

24. The device as claimed in claim 23 wherein the top surface of the outer wall is able to move relative to the inner support.

25. A device for supporting a wrist comprising:
an enclosure having a flexible outer wall in the form of a bladder or sac;
a first flowable material contained within the flexible outer wall; and
an inner support member within the flexible outer wall, wherein the outer wall is able to roll over a work surface and relative to the inner support member, wherein the inner support member comprises an inner chamber with a second flowable material therein that has greater viscosity than the first flowable material, and wherein the inner chamber includes an interior support member.

26. The device as claimed in claim 25, wherein the interior support member is planar.

27. The device as claimed in claim 26 wherein the interior support member is resilient.
